(19) United States
(12) Patent Application Publication
(10) Pub. No.: US 2022/0152811 A1
(43) Pub. Date: May 19, 2022

(54) SYSTEMS AND METHODS FOR MANAGING HAND TOOLS

(71) Applicant: Workshops for Warriors, San Diego, CA (US)

(72) Inventor: Hernán Luis y Prado, San Diego, CA (US)

(21) Appl. No.: 16/953,143

(22) Filed: Nov. 19, 2020

(51) Int. Cl. B25H 3/04

(52) U.S. Cl. CPC B25H 3/04

(57) ABSTRACT

A hand tool storage system includes a frame that includes a front panel, a first side panel angularly coupled to a first edge of the front panel, and a second side panel angularly coupled to a second edge of the front panel; and a plurality of slots formed in the frame, each of the slots forming an aperture that extends across a portion of the front panel and across a portion of each of the first and second side panels and sized to receive a hand tool contactingly supported by the first and second side panels.

### TECHNICAL FIELD

This specification relates to systems and method for managing hand tools.

### BACKGROUND

Hand tools, such as hammers, screwdrivers, wrenches, pliers, and other tools, are often stored in a common location, such as a tool box, with no separation or organization between different types of tools, as well as no separation or organization between hand tools of the same type but of different sizes. Such common storage techniques often make it difficult for a human operator to quickly and efficiently find the correct hand tool for a particular task.

### SUMMARY

In a general implementation according to the present disclosure, a hand tool storage system includes a frame that includes a front panel, a first side panel angularly coupled to a first edge of the front panel, and a second side panel angularly coupled to a second edge of the front panel; and a plurality of slots formed in the frame, each of the slots forming an aperture that extends across a portion of the front panel and across a portion of each of the first and second side panels and sized to receive a hand tool contactingly supported by the first and second side panels.

In an aspect combinable with the general implementation, the front panel is integrally formed with the first and second side panels.

In another aspect combinable with any of the previous aspects, each of the first and second side panels are orthogonally coupled to the front panel.

In another aspect combinable with any of the previous aspects, the hand tool includes an adjustable wrench.

In another aspect combinable with any of the previous aspects, the adjustable wrench includes a box wrench.

Another aspect combinable with any of the previous aspects further includes a plurality of labels formed on at least one of the front panel, the first side panel, or the second side panel.

In another aspect combinable with any of the previous aspects, at least one of the plurality of labels is formed on the front panel.

In another aspect combinable with any of the previous aspects, at least one of the plurality of labels is etched into the at least one of the front panel, the first side panel, or the second side panel.

In another aspect combinable with any of the previous aspects, at least one of the plurality of labels including a size indication of the hand tool.

In another aspect combinable with any of the previous aspects, a portion of each aperture that extends across the portion of each of the first and second side panels is angled relative to a portion of each aperture that extends across the front panel.

In another aspect combinable with any of the previous aspects, the frame is configured to mount on or to a support surface.

In another general implementation, a method for managing hand tools includes identifying a hand tool storage system positioned on a support surface. The hand tool storage system includes a frame that includes a front panel, a first side panel angularly coupled to a first edge of the front panel, and a second side panel angularly coupled to a second edge of the front panel, and a plurality of slots formed in the frame, each of the slots forming an aperture that extends across a portion of the front panel and across a portion of each of the first and second side panels and sized to receive a hand tool. The method includes placing a first hand tool in a first aperture in contacting support with the first and second side panels; and placing a second hand tool in a second aperture in contacting support with the first and second side panels.

In an aspect combinable with the general implementation, the front panel is integrally formed with the first and second side panels.

In another aspect combinable with any of the previous aspects, each of the first and second side panels are orthogonally coupled to the front panel.

In another aspect combinable with any of the previous aspects, at least one of the first or second hand tools includes an adjustable wrench.

In another aspect combinable with any of the previous aspects, the adjustable wrench includes a box wrench.

In another aspect combinable with any of the previous aspects, the hand tool storage system further includes a plurality of labels formed on at least one of the front panel, the first side panel, or the second side panel, and placing the first hand tool in the first aperture in contacting support with the first and second side panels includes placing the first hand tool in the first aperture according to a first label that describes a size of the first hand tool.

In another aspect combinable with any of the previous aspects, at least one of the plurality of labels is formed on the front panel.

In another aspect combinable with any of the previous aspects, at least one of the plurality of labels is etched into the at least one of the front panel, the first side panel, or the second side panel.

In another aspect combinable with any of the previous aspects, placing the second hand tool in the second aperture in contacting support with the first and second side panels includes placing the second hand tool in the second aperture according to a second label that describes a size of the second hand tool different than the first hand tool.

In another aspect combinable with any of the previous aspects, a portion of each aperture that extends across the portion of each of the first and second side panels is angled relative to a portion of each aperture that extends across the front panel.

Another aspect combinable with any of the previous aspects further includes mounting the frame to the support surface.

Implementations of a hand tool storage system according to the present disclosure can include one, some, or all of the following features. For example, implementations of a hand tool storage system according to the present disclosure can provide for better organization of one or more hand tools of different sizes. As another example, implementations of a hand tool storage system according to the present disclosure can maintain or help maintain accountability of such tools. As another example, implementations of a hand tool storage system according to the present disclosure can allow for rapid and efficient visual determination of any missing hand tools in a set of hand tools. As a further example, implementations of a hand tool storage system according to the present disclosure can reduce, for example up to three times, an amount of volumetric space required to store a given number of hand tools. As a further example, implementations of a hand tool storage system according to the present disclosure can may for easier identification of tools that are missing (e.g., just at a glance), which may be crucial for any industry that has an issue with foreign object debris (FOD) such as aerospace, defense, nuclear, and others, that need to quickly account for and identify missing tools or halt operations until such tools are found. As a further example, implementations of a hand tool storage system according to the present disclosure can be useful in penal training facilities, where misplaced/stolen tools could be used as a way of facilitating egress. As another example, implementations of a hand tool storage system according to the present disclosure can allow for quick visual inventory of tools that can be used in conjunction with automated visual tool control systems that incorporate scanners and cameras.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF DRAWINGS

FIGS. 1-4 are illustrations of an example implementation of all or a portion of a hand tool storage system.

FIG. 5 is an illustration of multiple hand tool storage systems mounted on a support surface.

### DETAILED DESCRIPTION

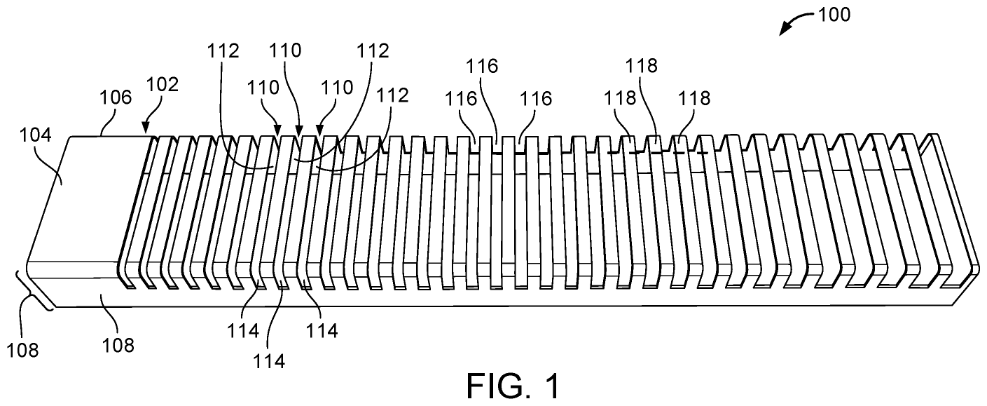

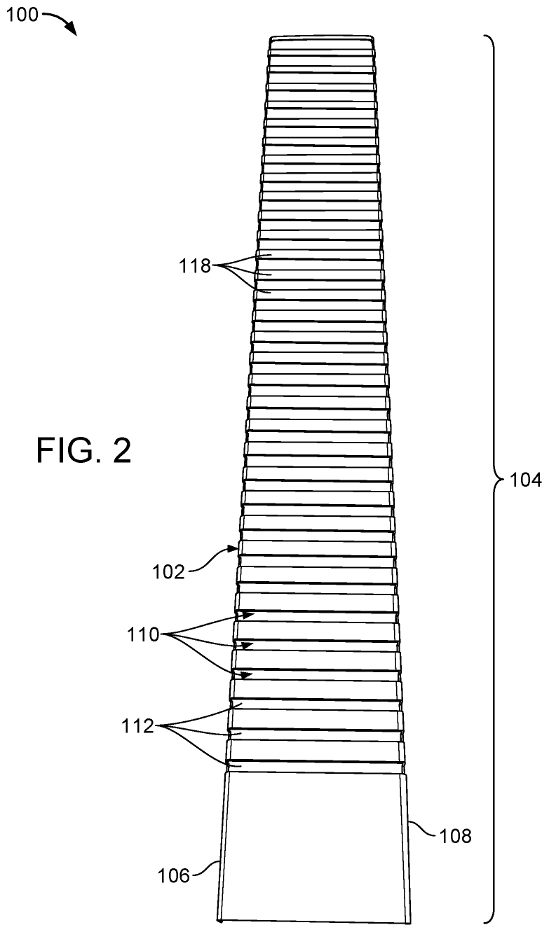

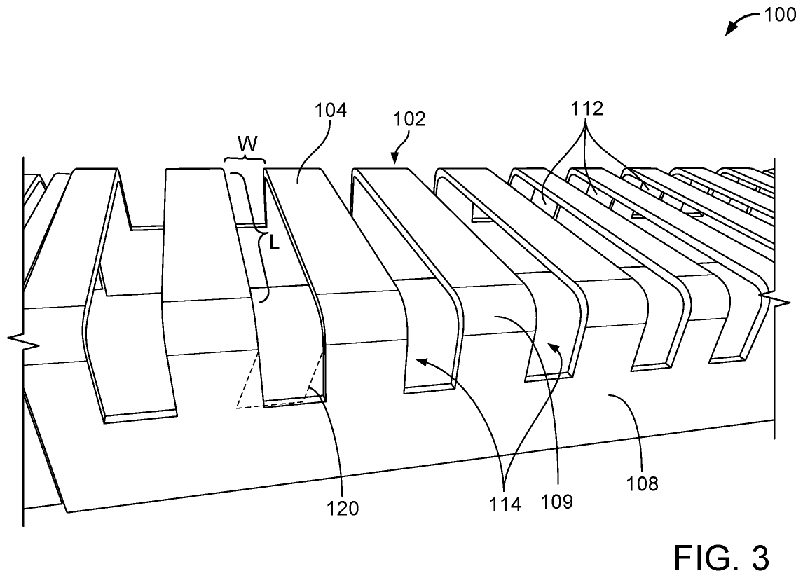

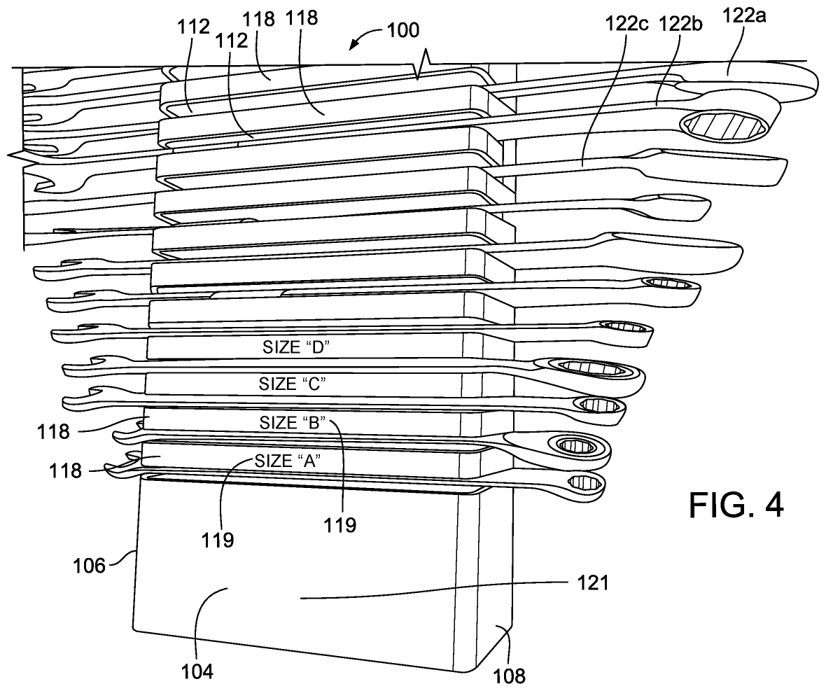

FIGS. 1-4 are illustrations of an example implementation of all or a portion of a hand tool storage system 100 according to the present disclosure. FIG. 1 shows an isometric view of the hand tool storage system 100; FIG. 2 shows an angled, top view of the hand tool storage system 100; FIG. 3 shows a side, isometric view of a portion of the hand tool storage system 100; and FIG. 4 shows an angled, top view of a portion of the hand tool storage system 100 that includes one or more hand tools 122a-122c mounted therein. As shown in FIG. 1, the hand tool storage system 100 includes a frame 102 that, in this example, comprises a front panel 104 and side panels 106 and 108. As shown in the figures, the side panels 106 and 108 are coupled to, or integral with, the front panel 104 so as to form a “u-shaped” structure if viewed from either end of the frame 102.

In this example, the side panels 106 and 108 are coupled to, or integral with, the front panel 104 at orthogonal angles, as shown in FIGS. 2-4. Other example implementations can have side panels 106 and 108 that are coupled to, or integral with, the front panel 104 at acute or obtuse angles. As further shown in FIG. 3, a rounded edge 109 can be formed at a location at which the side panel 108 (or side panel 106 opposite side panel 108) connects to the front panel 104. In some aspects, the frame 102 can be formed from a rigid material, such as metal (e.g., stainless steel, aluminum, or otherwise), plastic (e.g., polyvinyl chloride or otherwise), wood, or other rigid material.

As shown in the figures, multiple slots 110 are formed in the frame 102. Each slot 110 defines a void that is a cutout from a portion of each of the front panel 104, the side panel 106, and the side panel 108. In some aspects, each slot 110 is of same or similar dimensions (e.g., width (W) and length (L) across the front panel 104); in alternative aspects, different slots 110 can have different dimensions (e.g., width (W) and length (L) across the front panel 104). The dimensions, in some aspects, can be selected for the slots 110 based on all or a portion of a dimension or size of a hand tool, such as a hammers, screwdrivers, wrenches, pliers, and other tools. In the example implementation of FIG. 4, the example hand tools 122a, 122b, and 122c are box (or crescent) wrenches. As shown in FIG. 4, each hand tool 122a, 122b, and 122c (as well as the other hand tools shown) can be of a different size. In the example of the box wrenches in this figures, each box wrench can be of a different size (e.g., sized to rotate a different sized fastener) than the other box wrenches.

In the example implementation of FIGS. 1-4, each slot 110 is comprised of an aperture 112 formed across the front panel 104, an aperture 114 formed across a portion of the side panel 108, and an aperture 116 formed across a portion of the side panel 106. Thus, in this example, a slot 110 includes one aperture 112, one aperture 114, and one aperture 116 to form a contiguous aperture or cutout in the frame 102 (i.e., slot 110) that extends across the front panel 104 and into a portion of each of the side panels 106 and 108. In some aspects, the width (W) of the slot 110 is the same for each of apertures 112, 114, and 116. In other aspects, the width (W) can vary between the aperture 112 and the apertures 114 and 116 (e.g., the width (W) of the aperture 112 can be less than the widths of the apertures 114 and 116). As shown in FIGS. 1-2, bars 118 are thereby defined (and part of the front panel 104) between slots 110 (i.e., between apertures 112).

As shown in FIG. 4 and describes, each slot 110, through the apertures 112, 114, and 116, is designed and configured to receive a particular hand tool (such as one of hand tools 122a, 122b, or 122c). Once received, the particular hand tool can be on contacting support with the front panel 104 and the side panels 106 and 108 and within the slot 110. In some aspects, such as shown in FIG. 3, any (one, some, or all) particular aperture 114 or 116 can be an angled aperture 120 and be angled with respect to the aperture 112 (as shown). In such aspects, the angled apertures 120 can be appropriate to better engage and hold respective hand tools when the frame 102 is mounted vertically (e.g., on a support surface, such as a wall, door, or otherwise) with respect to the direction of gravity.

As shown in FIG. 4, labels 119 can be formed (e.g., etched, burned, painted, drawn, or otherwise) on one or more of the bars 118. In this example, each label 119 (with placeholders of “Size ‘A’” and “Size ‘B’” etc. shown) describes a particular or unique hand tool size that corresponds to the particular hand tool that is positioned in the slot 110 adjacent (on one side or the other as desired) the label 119. Thus, for an example implementation of the hand tool storage system 100 that stores box wrenches, each label 119 can correspond to a fastener size for which the box wrench positioned in that slot 110 (adjacent the label 119) fits. Example labels 119 can be, therefore, “1 inch,” “½ inch,” and so on in the English system, or “10 mm,” 12 mm,” and so on in the metric system. In some aspects, the labels 119 can be positioned or formed on one or both of side panels 106 or 108 adjacent the apertures 116 and 114, respectively. Other identifying information of the hand tool storage system 100 can be placed or formed, for example, an on area 121 of the front panel 104 (as shown in FIG. 4).

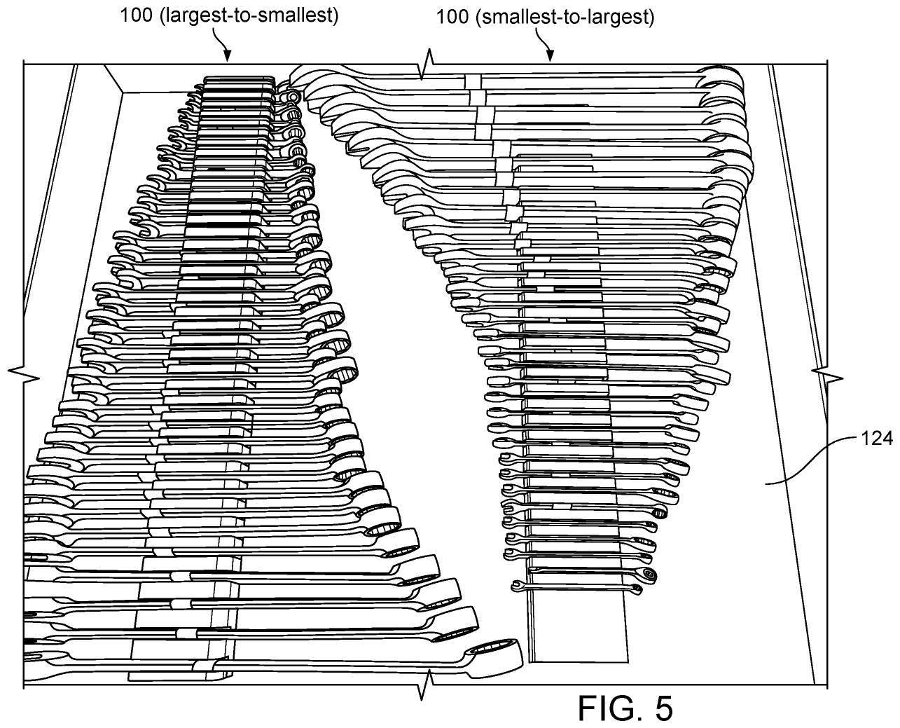

FIG. 5 is an illustration of multiple hand tool storage systems 100 mounted on a support surface 124. In this example, the support surface 124 is a bottom panel of a drawer, such as in a tool box, cabinet, or other container. But the support surface 124 on which one or more hand tool storage systems 100 can be positioned (or attached, such as by the frame 102) can be any planar or substantially planar horizontal, vertical, or angled surface. As shown in FIG. 5, two hand tool storage systems 100 are shown. Each hand tool storage system 100 includes hand tools (here, box wrenches) positioned in their respective slots. In order for both hand tool storage systems 100 to fit on the support surface 124 (and in, e.g., the drawer or cabinet), the hand tools are placed in a smallest-to-largest size order in one of the two hand tool storage systems 100 and in a largest-to-smallest size order in the other of the two hand tool storage systems 100 (as shown). Thus, multiple hand tool storage systems 100 can be efficiently positioned on the support surface 124 (or in a container).

A number of implementations have been described. Nevertheless, it will be understood that various modifications can be made without departing from the spirit and scope of the disclosure. For example, example operations, methods, or processes described herein may include more steps or fewer steps than those described. Further, the steps in such example operations, methods, or processes can be performed in different successions than that described or illustrated in the figures. Accordingly, other implementations are within the scope of the following claims.

1. A hand tool storage system, comprising:
a frame formed from a single front panel, a first side panel angularly coupled to a first edge of the front panel, and a second side panel angularly coupled to a second edge of the front panel, the frame configured to mount on or to a support surface such that the frame is vertically oriented with respect to gravity;
a plurality of slots formed in the frame, each of the slots forming an aperture that extends across the front panel from the first edge of the front panel to the second edge of the front panel, and across a portion of each of the first and second side panels and sized to receive a hand tool contactingly supported by the first and second side panels, wherein each aperture that extends across the portion of each of the first and second side panels is acutely angled relative to each aperture that extends across the front panel; and
a plurality of bars that connect the first side panel and the second side panel between the plurality of slots to form at least a portion of the front panel, each of the plurality of bars extending from the first edge of the front panel to the second edge of the front panel and having a length across the front panel that is substantially constant and is equal to a length of the plurality of slots.

2. The hand tool storage system of claim 1, wherein the front panel is integrally formed with the first and second side panels.

3. The hand tool storage system of claim 1, wherein each of the first and second side panels are orthogonally coupled to the front panel.

4. The hand tool storage system of claim 1, wherein the hand tool comprises an adjustable wrench.

5. The hand tool storage system of claim 4, wherein the adjustable wrench comprises a box wrench.

6. The hand tool storage system of claim 1, further comprising a plurality of labels formed on at least one of the front panel, the first side panel, or the second side panel.

7. The hand tool storage system of claim 6, wherein at least one of the plurality of labels is formed on the front panel.

8. The hand tool storage system of claim 6, wherein at least one of the plurality of labels is etched into the at least one of the front panel, the first side panel, or the second side panel.

9. The hand tool storage system of claim 6, wherein at least one of the plurality of labels comprises a size indication of the hand tool.

10. (canceled)

11. (canceled)

12. A method for managing hand tools, comprising:
identifying a hand tool storage system that is vertically mounted on a support surface with respect to gravity, the hand tool storage system comprising:
a frame formed from a single front panel, a first side panel angularly coupled to a first edge of the front panel, and a second side panel angularly coupled to a second edge of the front panel,
a plurality of slots formed in the frame, each of the slots forming an aperture that extends across the front panel from the first edge of the front panel to the second edge of the front panel, and across a portion of each of the first and second side panels and sized to receive a hand tool, wherein each aperture that extends across the portion of each of the first and second side panels is acutely angled relative to each aperture that extends across the front panel, and
a plurality of bars that connect the first side panel and the second side panel between the plurality of slots to form at least a portion of the front panel, each of the plurality of bars extending from the first edge of the front panel to the second edge of the front panel and having a length across the front panel that is substantially constant and is equal to a length of the plurality of slots;
placing a first hand tool in a first aperture in contacting support with the first and second side panels; and
placing a second hand tool in a second aperture in contacting support with the first and second side panels.

13. The method of claim 12, wherein the front panel is integrally formed with the first and second side panels.

14. The method of claim 12, wherein each of the first and second side panels are orthogonally coupled to the front panel.

15. The method of claim 12, wherein at least one of the first or second hand tools comprises an adjustable wrench.

16. The method of claim 15, wherein the adjustable wrench comprises a box wrench.

17. The method of claim 12, wherein the hand tool storage system further comprises a plurality of labels formed on at least one of the front panel, the first side panel, or the second side panel, and placing the first hand tool in the first aperture in contacting support with the first and second side panels comprises placing the first hand tool in the first aperture according to a first label that describes a size of the first hand tool.

18. The method of claim 17, wherein at least one of the plurality of labels is formed on the front panel.

19. The method of claim 17, wherein at least one of the plurality of labels is etched into the at least one of the front panel, the first side panel, or the second side panel.

20. The method of claim 17, wherein placing the second hand tool in the second aperture in contacting support with the first and second side panels comprises placing the second hand tool in the second aperture according to a second label that describes a size of the second hand tool different than the first hand tool.

21. (canceled)

22. The method of claim 12, further comprising mounting the frame to the support surface.

23. The hand tool storage system of claim 1, wherein the aperture of each slot of the plurality of slots is defined by a width and the length, and the width of the aperture of a first slot of the plurality of slots is different than the width of the aperture of a second slot of the plurality of slots based on a size of a first hand tool receivable into the first slot different than a size of a second hand tool receivable into the second slot, and the length of the aperture of the first slot of the plurality of slots is the same as the length of the aperture of the second slot.

24. The hand tool storage system of claim 23, wherein the width of the aperture of the first slot of the plurality of slots is defined by:
a first slot width that defines a distance across the aperture at the front panel;
a second slot width that defines a distance across the aperture at the first side panel; and
a third slot width that defines a distance across the aperture at the second side panel, where the second and third slot widths are equal, and the first slot width is different than the second and third slot widths.

25. The hand tool storage system of claim 24, wherein the first slot width is less than the second and third slot widths.
